(19) United States
(12) Patent Application Publication
(10) Pub. No.: US 2023/0132179 A1
(43) Pub. Date: Apr. 27, 2023

(54) TOW MANAGEMENT SYSTEMS AND METHODS FOR AUTONOMOUS VEHICLES

(71) Applicant: GM GLOBAL TECHNOLOGY OPERATIONS LLC, Detroit, MI (US)

(72) Inventors: Rasoul Salehi, Ann Arbor, MI (US); Arun Adiththan, Sterling Heights, MI (US); Yilu Zhang, Northville, MI (US); Yao Hu, Sterling Heights, MI (US)

(73) Assignee: GM GLOBAL TECHNOLOGY OPERATIONS LLC, Detroit, MI (US)

(21) Appl. No.: 17/452,299

(22) Filed: Oct. 26, 2021

(51) Int. Cl. B60W 60/00; G05D 1/10; G07C 5/00

(52) U.S. Cl. CPC B60W 60/0025; G05D 1/101; G07C 5/008; B60W 2556/65

(57) ABSTRACT

Methods and systems for a remote transportation system including a first autonomous vehicle, at least one second autonomous vehicle and a remote transportation server are provided. The at least one second autonomous vehicle includes non-transitory computer readable media and one or more processors configured by programming instructions on the non-transitory computer readable media to: receive a request for tow service from the remote transportation server, wherein the request includes a location of the first autonomous vehicle; locate and identify the first autonomous vehicle based on the request; create a communicate link between the first autonomous vehicle and the second autonomous vehicle; select at least one of a centralized towing method and a projection-based towing method based on the request; and perform autonomous towing of the first autonomous vehicle based on the selected of the at least one of the centralized towing method and the projection-based towing method.

### TECHNICAL FIELD

The technology described in this patent document relates generally to towing of autonomous vehicles, and more particularly to systems and methods for towing autonomous vehicles using an autonomous vehicle.

An autonomous vehicle is a vehicle that can sense its environment and navigating with little or no user input. An autonomous vehicle senses its environment using sensing devices such as radar, lidar, image sensors, and the like. The autonomous vehicle system further uses information from a positioning system including global positioning systems (GPS) technology, navigation systems, vehicle-to-vehicle communication, vehicle-to-infrastructure technology, and/or drive-by-wire systems to navigate the vehicle.

In some instances, an autonomous vehicle may be unable to continue driving due to, for example, a fault in one or more systems of the vehicle. In such cases, it may be desirable to tow the autonomous vehicle to a location where the fault can be evaluated and/or repaired. It is desirable to have another autonomous vehicle tow the faulty autonomous vehicle.

Accordingly, it is desirable to provide systems and methods for managing the towing of autonomous vehicles using an autonomous vehicle. Furthermore, other desirable features and characteristics will become apparent from the subsequent detailed description and the appended claims, taken in conjunction with the accompanying drawings.

### SUMMARY

Methods and systems for a remote transportation system including a first autonomous vehicle, at least one second autonomous vehicle and a remote transportation server are provided. The at least one second autonomous vehicle includes non-transitory computer readable media and one or more processors configured by programming instructions on the non-transitory computer readable media to: receive a request for tow service from the remote transportation server, wherein the request includes a location of the first autonomous vehicle; locate and identify the first autonomous vehicle based on the request; create a communicate link between the first autonomous vehicle and the second autonomous vehicle; select at least one of a centralized towing method and a projection-based towing method based on the request; and perform autonomous towing of the first autonomous vehicle based on the selected of the at least one of the centralized towing method and the projection-based towing method.

In various embodiments, the centralized towing method determines control commands for operation of the first autonomous vehicle and communicates the control commands to the first autonomous vehicle.

In various embodiments, the projection-based towing method determines sensor information for use in operating the first autonomous vehicle and communicates the sensor data to the first autonomous vehicle.

In various embodiments, the projection-based towing method determines perception information for use in operating the first autonomous vehicle and communicates the perception data to the first autonomous vehicle.

In various embodiments, the processor is configured to monitor the autonomous towing of the first vehicle; and adapt towing parameters of the at least one of the centralized towing method and the projection-based towing method based on the monitoring.

In various embodiments, the processor is configured to monitor by detecting uncertainty in feedback signals from the first autonomous vehicle and the second autonomous vehicle.

In various embodiments, the second autonomous vehicle is an aerial autonomous vehicle.

In various embodiments, second autonomous vehicle is a ground based autonomous vehicle.

In various embodiments, the second autonomous vehicle is a sensor kit.

In various embodiments, the request includes parameters identifying physical characteristics of the first autonomous vehicle and fault codes of the first autonomous vehicle.

In another embodiment a method includes: receiving a request for tow service from the remote transportation server, wherein the request includes a location of the first autonomous vehicle; locating and identify the first autonomous vehicle based on the request; creating a communicate link between the first autonomous vehicle and the second autonomous vehicle; selecting at least one of a centralized towing method and a projection-based towing method based on the request; and performing autonomous towing of the first autonomous vehicle based on the selected of the at least one of the centralized towing method and the projection-based towing method.

In various embodiments, the centralized towing method determines control commands for operation of the first autonomous vehicle and communicates the control commands to the first autonomous vehicle.

In various embodiments, the projection-based towing method determines sensor information for use in operating the first autonomous vehicle and communicates the sensor data to the first autonomous vehicle.

In various embodiments, the projection-based towing method determines perception information for use in operating the first autonomous vehicle and communicates the perception data to the first autonomous vehicle.

In various embodiments, the method includes: monitoring the autonomous towing of the first vehicle; and adapting towing parameters of the at least one of the centralized towing method and the projection-based towing method based on the monitoring.

In various embodiments, the monitoring includes detecting uncertainty in feedback signals from the first autonomous vehicle and the second autonomous vehicle.

In various embodiments, the second autonomous vehicle is an aerial autonomous vehicle.

In various embodiments, second autonomous vehicle is a ground based autonomous vehicle.

In various embodiments, the second autonomous vehicle is a sensor kit.

In various embodiments, the request includes parameters identifying physical characteristics of the first autonomous vehicle and fault codes of the autonomous vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram illustrating an example transportation system for providing towing services, in accordance with various embodiments;

FIG. 2 is a block diagram illustrating an example autonomous vehicle that may be used in the example transportation system as a towing vehicle or a towed vehicle, in accordance with various embodiments; and

FIGS. 3, 4, and 5 are flowcharts illustrating methods performed by one or more elements of the transportation system to perform the towing services, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, and articles for a transportation system that enables management methods, systems, and interactions of the transportation system and an autonomous vehicle to initiate, plan, coordinate, and end a tow process with an autonomous vehicle. In various embodiments, the transportation system is a back-office type transportation system that is remote from the autonomous vehicle. In various embodiments, the host vehicle is an autonomous vehicle.

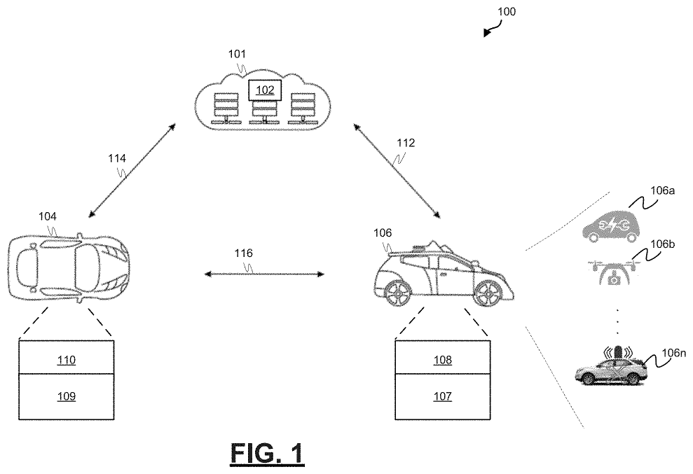

With refence now to FIG. 1, a functional block diagram illustrates an example transportation system 100 in accordance with various embodiments. In various embodiments, the transportation system 100 includes a towing service module 102, one or more autonomous vehicles 104, and one or more towing vehicles 106. The towing vehicles 106 can include, but are not limited to ground based autonomous vehicles 106a, aerial autonomous vehicles 106b, and sensor kits 106n. In general, the transportation system 100 enables a towing service with programmed modules, sensors, and communication systems that enable one or more of the autonomous vehicles 104 to be towed by one of the towing vehicles 106a-106n.

For example, the towing service allows for fully autonomous equipped vehicles or sensor kits that enable autonomous operation to extend their autonomous driving capabilities to other autonomous vehicles that may be unable to operate due to a fault. In various embodiments, the autonomous vehicle 106 (whether it be a full vehicle or a sensor kit) is configured with at least one controller 107 that includes a towing module 108 that controls the autonomous vehicle 106 to lead the autonomous vehicle 104 to a location that, for example, may service the fault of the autonomous vehicle. The leading can be by way of providing control commands for the autonomous vehicle 104 to follow or by way of providing sensed data or perception data for the autonomous vehicle to evaluate when determining towing commands, and/or by providing a combination of control commands and sensed/perception data.

The autonomous vehicle 104 is configured with at least one controller 109 that includes a towing module 110 that controls the autonomous vehicle 104 to relinquish all or parts of driving control to the vehicle 106 for the trip to the service location by following the vehicle 106 and/or following the commands or sensor data of the sensor kit.

In various embodiments, the vehicle 106 is communicatively coupled to the towing service module 102 via a communication link 112, and the autonomous vehicle 104 is communicatively coupled to the towing service module 102 via a communication link 114.

Through the communication links 112, 114, the towing service module 102 can facilitate setup of a tow between the autonomous vehicle 106 and the autonomous vehicle 104, monitor the tow procedure, communicate status information regarding the tow procedure to each other, communicate tow termination requests between the autonomous vehicles 104, 106, communicate safety information between the autonomous vehicles 104, 106, as well as other tasks to enable an effective towing service.

In various embodiments, the autonomous vehicle 106 is dynamically coupled to the autonomous vehicle 104 via a virtual link 116. The virtual link 116 is established when a need for towing has been identified and the autonomous vehicle 104 is in proximity to the autonomous vehicle 106. In various embodiments, the virtual link 116 and the communication links 112, 114, may be implemented using a wireless carrier system such as a cellular telephone system and/or a satellite communication system. The wireless carrier system can implement any suitable communications technology, including, for example, digital technologies such as CDMA (e.g., CDMA2000), LTE (e.g., 4G LTE or 5G LTE), GSM/GPRS, or other current or emerging wireless technologies.

The communication links 112, 114, may also be implemented using a conventional land-based telecommunications network coupled to the wireless carrier system. For example, the land communication system may include a public switched telephone network (PSTN) such as that used to provide hardwired telephony, packet-switched data communications, and the Internet infrastructure. One or more segments of the land communication system can be implemented using a standard wired network, a fiber or other optical network, a cable network, power lines, other wireless networks such as wireless local area networks (WLANs), or networks providing broadband wireless access (BWA), or any combination thereof.

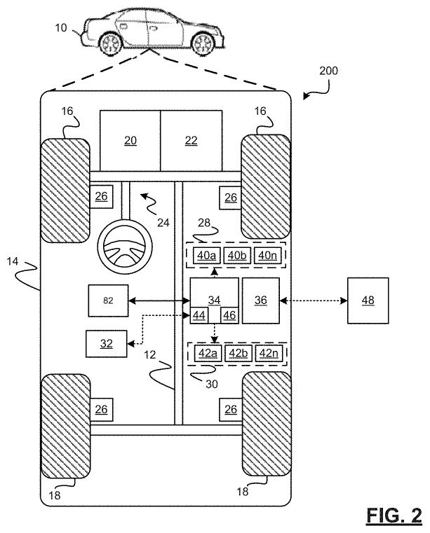

Referring now to FIG. 2, a block diagram illustrates an example vehicle 200 that may be used in the example transportation system 100 as either the autonomous vehicle 106 or the autonomous vehicle 104. The example vehicle 200 generally includes a chassis 12, a body 14, front wheels 16, and rear wheels 18. The body 14 is arranged on the chassis 12 and substantially encloses components of the vehicle 200. The body 14 and the chassis 12 may jointly form a frame. The wheels 16-18 are each rotationally coupled to the chassis 12 near a respective corner of the body 14. The vehicle 200 is depicted in the illustrated embodiment as a passenger car, but other vehicle types, including trucks, sport utility vehicles (SUVs), recreational vehicles (RVs), etc., may also be used.

The vehicle 200 may be capable of level Four or Five automation. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

In various embodiments, the vehicle 200 further includes a propulsion system 20, a transmission system 22 to transmit power from the propulsion system 20 to vehicle wheels 16-18, a steering system 24 to influence the position of the vehicle wheels 16-18, a brake system 26 to provide braking torque to the vehicle wheels 16-18, a sensor system 28, an actuator system 30, at least one data storage device 32, at least one controller 34, a communication system 36 that is configured to wirelessly communicate information to and from other entities 48, such as the other vehicle 104, 106 and the towing service module 102, and a notification device 82 that generates visual, audio, and/or haptic notifications to users in proximity to the vehicle 200.

The sensor system 28 includes one or more sensing devices 40a-40n that sense observable conditions of the exterior environment and/or the interior environment of the autonomous vehicle 10. The sensing devices 40a-40n can include, depending on the level of autonomy of the vehicle 200, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26.

The communication system 36 is configured to wirelessly communicate information to and from the other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the vehicle 200. The data storage device 32 may be part of the controller 34, separate from the controller 34, or part of the controller 34 and part of a separate system. The controller 34 includes at least one processor 44 and a computer-readable storage device or media 46. Although only one controller 34 is shown in FIG. 2, embodiments of the vehicle 200 may include any number of controllers 34 that communicate over any suitable communication medium or a combination of communication mediums and that cooperate to process the sensor signals, perform logic, calculations, methods, and/or algorithms, and generate control signals to automatically control features of the vehicle 200.

The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34.

The programming instructions may include one or more separate programs, each of which comprises an ordered listing of executable instructions for implementing logical functions. In various embodiments, the instructions may be implemented in the towing module 108 (FIG. 1) or the towing module 110 (FIG. 1). The instructions, when executed by the processor, perform towing functions of the vehicles 104, 106 as will be discussed in more detail below.

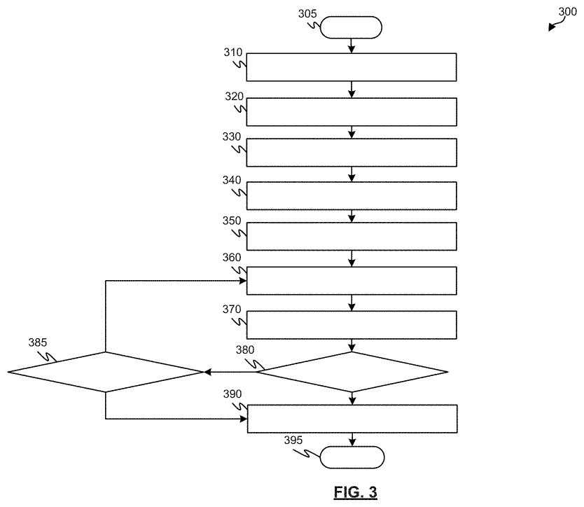

Referring now to FIGS. 3-5 and with continued reference to FIGS. 1-2, flowcharts illustrate control methods 300, 400, and 600 that can be performed by system 100 of FIG. 1, and more particularly by the towing service module 102, the towing module 110 and/or the towing module 108 in accordance with the present disclosure. As can be appreciated in light of the disclosure, the order of operation within the control methods 300, 400, and 600 is not limited to the sequential execution as illustrated in FIG. 3-5 but may be performed in one or more varying orders as applicable and in accordance with the present disclosure. In various embodiments, the methods 300, 400, and 600 can be scheduled to run based on one or more predetermined events, and/or can run continuously during operation of the system 100.

In one example, the method 300 of FIG. 3 may be performed by the towing module 108 of the vehicle 106 to perform the towing service. The method 300 may begin at 305. The tow request and any towing information communicated by the towing service module 102 is received at 310. In various embodiments, the tow information includes an indication of the failure that is causing the request for a tow (e.g., fault codes, etc.), a location of the vehicle 104, parameters identifying physical characteristics of the vehicle 104, and/or any time constraints. The tow request is processed at 420 to locate and identify the autonomous vehicle 104 at 320. Once the vehicle 104 is identified the vehicle 106 is controlled to a position near the vehicle 104 at 330.

The virtual link is established at 340.

Tow logic is then selected and initiated at 350, for example, based on the tow information such as the fault type. For example, the tow logic can be for a centralized towing method where control commands for the vehicle 104 (e.g., planning commands, controller commands, actuator commands, etc.) are determined and communicated to the vehicle 104, or a projection-based towing method where sensor/perception information is determined and communicated to the vehicle 104 and the vehicle 104 determines the control commands. The selected tow logic is performed to tow the vehicle 104 to the destination at 360. The towing process is monitored at 370 and any logic is adapted if errors are encountered. The towing logic is performed until the towing is complete at 385 or when the adaption is not successful at 380. Thereafter, the vehicle 104 is stopped at the destination and the towing is ended at 390. Thereafter, the method may end at 395.

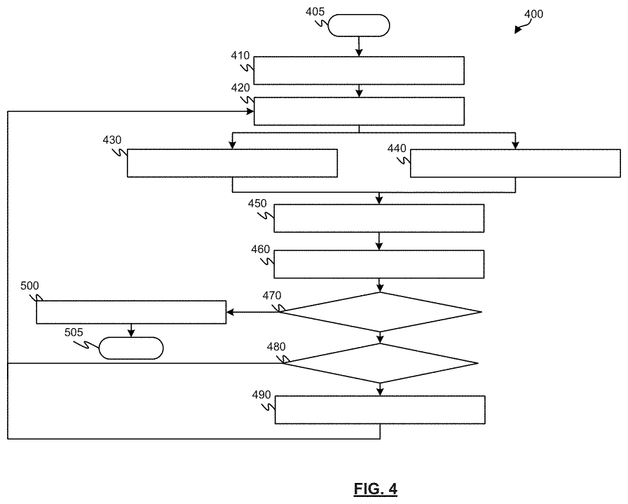

In another example, the method 400 of FIG. 4 may be performed by the towing module 108 to perform the centralized towing. The method may begin at 405. Host vehicle parameters are received at 410. Perception logic is performed at 420 to identify elements of the environment. Host vehicle control commands and a host vehicle path are determined at 430 and 440 based on the perception information.

For example, control commands for steering and pedal control can be computed using:

$${arg min}_{U} {\sum }_{K = 1}^{K = n} {( X - {X}_{ref} )}_{k}^{T} {Q ( X - {X}_{ref} )}_{k} ,$$

Sub. to:

X(k+1)=f(X(k),U(k)),

Dₘᵢₙ≤X₁−X_{1,lead}≤Dₘₐₓ,

A_{long,min}≤X₅≤A_{long,max},

A_{lat,min}≤X₆≤A_{lat,max},

X∈χ_{corridor},

Xₒₜₕₑᵣ∉χ_{corridor},

U∈

[symbol]

Where

U=[θ_{pedal},θₛₜₑₑᵣ], and

X=[x₁,x₂,x₃,x₄,x₅,x₆]^{T}.

And where x₁, x₂ represents the longitude and latitude position, x₃, x₄ represent the longitude and latitude speed, x₅, x₆ represent the longitude and latitude acceleration, and Xₒₜₕₑᵣ represents states of other vehicles on the road.

In another example, the path planning can be computed provide a polynomial trajectory planning:

X_{ref}=Σᵢ₌₀ⁿCᵢtⁱ, and

X=[x₁,x₂,x₃,x₄,x₅,x₆]^{T}.

Where x₁, x₂ represents the longitude and latitude position, x₃, x₄ represent the longitude and latitude speed, x₅, x₆ represent the longitude and latitude acceleration.

In various embodiments, maneuvers are planned such that the towing and host vehicles always are observable (connected) to each other. In various embodiments, the planning considers the host vehicle and taxi specific parameters such as mass. In various embodiments, path planning considers both vehicles, for example, both vehicles should be able to pass the traffic light or other slow traffic conditions.

At 405, the host vehicle control commands are communicated to the vehicle 104. The vehicle 104 is monitored for vehicle states at 460. Thereafter, it is determined whether towing termination is required at 470. When towing termination is required at 470, the termination is planned, and the towing is ended at 500. Thereafter, the method 400 may end at 505.

If towing termination is not required at 470, it is determined whether errors were detected between commanded and measured signals at 480. For example, feedback signals (from the host vehicle) are used to detect high deviation between commanded path by the towing vehicle and executed path by the host vehicle based on the host vehicle states.

If errors were detected at 480, parameter adaption is activated at 490 and the method 400 continues with performing perception logic at 420. If errors are not detected at 480, the method 400 continues with performing the perception logic at 420. As can be appreciated, other parameters can be used to adapt the towing method, for example, feedback from the host vehicle passenger(s) such as comfort could also be used to adapt the towing method.

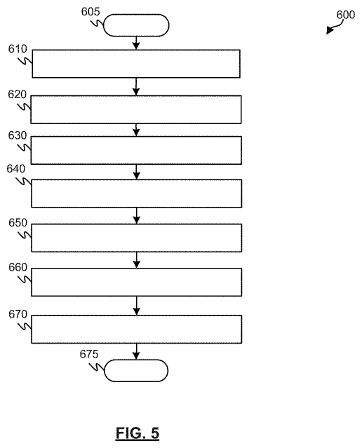

In another example, the method 600 of FIG. 5 may be performed by the towing module 108 to perform projection-based towing. The method 600 may begin at 605. Sensor data is received at 610. Host vehicle information (e.g., sensor values or perception data) is computed from the sensor data at 620. Host vehicle location and orientation is determined at 630. A transfer matrix is determined based on the host vehicle orientation at 640. The sensor data is converted to host vehicle coordinates based on the transfer matrix at 650. The converted sensor data is timestamped and encoded for proper synchronization at 660. The encoded data is then communicated to the vehicle 104 for further processing by the towing module 110 at 670. Thereafter, the method 600 may end at 675.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A remote transportation system comprising a first autonomous vehicle, at least one second autonomous vehicle and a remote transportation server, the at least one second autonomous vehicle comprising non-transitory computer readable media and one or more processors configured by programming instructions on the non-transitory computer readable media to:
receive a request for tow service from the remote transportation server, wherein the request includes a location of the first autonomous vehicle;
locate and identify the first autonomous vehicle based on the request;
create a communicate link between the first autonomous vehicle and the second autonomous vehicle;
select at least one of a centralized towing method and a projection-based towing method based on the request; and
perform autonomous towing of the first autonomous vehicle based on the selected of the at least one of the centralized towing method and the projection-based towing method.

2. The remote transportation system of claim 1, wherein the centralized towing method determines control commands for operation of the first autonomous vehicle and communicates the control commands to the first autonomous vehicle.

3. The remote transportation system of claim 1, wherein the projection-based towing method determines sensor information for use in operating the first autonomous vehicle and communicates the sensor information to the first autonomous vehicle.

4. The remote transportation system of claim 1, wherein the projection-based towing method determines perception information for use in operating the first autonomous vehicle and communicates the perception information to the first autonomous vehicle.

5. The remote transportation system of claim 1, wherein the processor is configured to monitor the autonomous towing of the first autonomous vehicle; and
adapt towing parameters of the at least one of the centralized towing method and the projection-based towing method based on the monitoring.

6. The remote transportation system of claim 5, wherein the processor is configured to monitor by detecting uncertainty in feedback signals from the first autonomous vehicle and the second autonomous vehicle.

7. The remote transportation system of claim 1, wherein the second autonomous vehicle is an aerial autonomous vehicle.

8. The remote transportation system of claim 1, wherein second autonomous vehicle is a ground based autonomous vehicle.

9. The remote transportation system of claim 1, wherein the second autonomous vehicle is a sensor kit.

10. The remote transportation system of 1, wherein the request includes parameters identifying physical characteristics of the first autonomous vehicle and fault codes of the first autonomous vehicle.

11. A method in remote transportation system comprising a first autonomous vehicle, at least one second autonomous vehicle and a remote transportation server, the method comprising:
receiving a request for tow service from the remote transportation server, wherein the request includes a location of the first autonomous vehicle;
locating and identify the first autonomous vehicle based on the request;
creating a communicate link between the first autonomous vehicle and the second autonomous vehicle;
selecting at least one of a centralized towing method and a projection-based towing method based on the request; and
performing autonomous towing of the first autonomous vehicle based on the selected of the at least one of the centralized towing method and the projection-based towing method.

12. The method of claim 11, wherein the centralized towing method determines control commands for operation of the first autonomous vehicle and communicates the control commands to the first autonomous vehicle.

13. The method of claim 11, wherein the projection-based towing method determines sensor information for use in operating the first autonomous vehicle and communicates the sensor information to the first autonomous vehicle.

14. The method of claim 11, wherein the projection-based towing method determines perception information for use in operating the first autonomous vehicle and communicates the perception information to the first autonomous vehicle.

15. The method of claim 11, further comprising monitoring the autonomous towing of the first vehicle; and
adapting towing parameters of the at least one of the centralized towing method and the projection-based towing method based on the monitoring.

16. The method of claim 15, wherein the monitoring comprises detecting uncertainty in feedback signals from the first autonomous vehicle and the second autonomous vehicle.

17. The method of claim 11, wherein the second autonomous vehicle is an aerial autonomous vehicle.

18. The method of claim 11, wherein second autonomous vehicle is a ground based autonomous vehicle.

19. The method of claim 11, wherein the second autonomous vehicle is a sensor kit.

20. The method of claim 11, wherein the request includes parameters identifying physical characteristics of the first autonomous vehicle and fault codes of the first autonomous vehicle.
